(19) United States
(12) Patent Application Publication
(10) Pub. No.: US 2004/0199539 A1
(43) Pub. Date: Oct. 7, 2004

(54) Method and system for supporting hierarchical tree filtering

(76) Inventors: Juliet Richardson, Winford (GB); Darin Keith Cavanaugh, Heathrow, FL (US); Brian Paul Zimmerman, Sanford, FL (US)

Correspondence Address: FROST BROWN TODD LLC, 2200 PNC Center, 201 E. Fifth Street, Cincinnati, OH, 45202-4182, US

(21) Appl. No.: 10/769,504

(22) Filed: Jan. 29, 2004

Related U.S. Application Data
(60) Provisional application No. 60/444,337, filed on Jan. 31, 2003.

(51) Int. Cl. G06F 17/00

(52) U.S. Cl. 707/102

(57) ABSTRACT

This application discloses a system and method for the computerized filtering of directory structures and an associated computerized graphical user interface to facilitate the selection of criteria and display of results.

This non-provisional patent application claims priority from the earlier filed provisional application Serial No. 60/444,337, which was filed on Jan. 31, 2003. That provisional application is hereby incorporated by reference into the current application.

### FIELD OF INVENTION

This invention is in the field of filtering computerized directories.

### BACKGROUND

In a computer, a file system is the way in which files are named and where they are logically placed for storage and retrieval. The DOS, Windows, OS/2, Macintosh, and UNIX-based operating systems all have file systems in which files are placed somewhere in a hierarchical (tree) structure. A file is placed in a directory (folder in Windows) or subdirectory at the desired place in the tree structure. In computer file systems, a directory is a group of related files that are separated by some naming convention from other groups of files.

File systems specify conventions for naming files. These conventions include the maximum number of characters in a name, which characters can be used, how long the file name suffix can be, etc. A file system also includes a format for specifying the path to a file through the structure of directories.

A directory may be graphically represented in a hierarchical tree structure including representations such as flow charts, vertical trees and hyperbolic (radial) trees.

Referring to FIG. 1, a tree structure is the embodiment of an algorithm for placing and locating files (called records or keys) in a database. The algorithm finds data by repeatedly making choices at decision points called nodes. A node can have as few as one branch (also called children), or as many as desired. The structure is straightforward, but in terms of the number of nodes/children, a tree can be gigantic.

In a tree, records are stored in locations called leaves (the term child also encompasses leaves). This name derives from the fact that records, generally, exist at end points. The starting point is called the root. The maximum number of children per node is called the order of the tree. The maximum number of access operations required to reach the desired record is called the depth. In some trees, the order is the same at every node and the depth is the same for every record. Other trees have varying numbers of children per node, and different records might lie at different depths. As the process moves toward the leaves and away from the root, children can branch out from a node.

In a practical tree, there can be thousands, millions, or billions of nodes, children, leaves, and/or records. Every leaf does not necessarily contain a record. A leaf that does not contain data is called a null. Trees are, generally, simple enough to be rendered in two dimensions. Some large databases, however, may need three dimensions to clearly depict the structure.

Flow chart trees (see, FIG. 2A) may be arranged horizontally or vertically. The main problem with this type of tree is that visual limitations exist when large hierarchies are displayed. Two methods to compensate for these problems include split-focus navigation and zooming. Even so, as the number of nodes increases, these approaches become less and less practical. Vertical trees (see, FIG. 2B) can be difficult to see in the horizontal plane, especially, when multiple levels are expanded. Resizing and horizontal scrolling are usually available to minimize but not eliminate this problem. Hyperbolic trees (see, FIG. 2C) are arranged radially. Icons represent the nodes and they are linked by lines. As the user clicks on a node, that node is brought into the center and the view of the tree is updated accordingly. The user can drag nodes or click on the edges of the visible tree to move the area of focus. Hyperbolic trees are best suited for hierarchical structures of limited size.

### SUMMARY OF THE INVENTION

Embodiments of the system and method disclosed in this application address a need in the industry for a robust, user interface to support filtering a directory. Various embodiments of the invention may be described in the context of supporting the billing industry, however, it should be appreciated that the disclosed embodiments may be applied to virtually any industry that may store files on a computer and need to organize them in a directory (i.e, education, law, medicine, utilities, etc.). To wit, the design may support the management of any hierarchies whether account-based, product-based, customer-based, file-based, directory structures on a personal computer, or any other organization of data in a hierarchical format.

In one embodiment there is a computerized method for filtering a directory comprising the steps of presenting a directory to a user wherein said directory comprises an organizational schema. A directory may comprise any logical file stored on computer media which represents the organization of data (possibly but not necessarily including the location of such data as well). In preferred embodiments, the organizational schema may be represented as a hierarchical tree but it would be reasonable to apply the precepts of this tool to other organization methodologies as well such as those described in the background section (including, but not limited to, flow chart trees and radial trees) as well as organizational formats yet to be developed. The user may send a signal which is received by the computer, software, system (which may include but is not limited to embodiments comprising processing means, some display means, and storage means which cooperate to accomplish the functions described in the various embodiments), etc. [hereinafter, collectively, computer] which indicates a particular node for which the user wishes to filter the children depending from that node. Signals comprise computer generated data which represent a choice made by the user. A node may comprise a directory folder in one embodiment, a heading in another embodiment or any other organizational “parent” in the structure.

A filter operates to block access to data that does or does not meet a particular criterion while, preferably, maintaining the organizational schema of the data. It differs from a search, which provides access to data, via a list, that does/does not meet a particular criterion.

While not necessarily the next step in the sequence, the user may select the criteria that the filter should or should not meet to produce a set of results. The computer may receive this signal and perform the filter operation. The result set may then be presented via visual means associated with the computer in the same organizational schema associated with said directory.

In another embodiment the computerized method may further include the steps of selecting a set of attributes associated with said node. Different attributes may be associated with different nodes in the same directory structure. The GUI may also permit a user (either an end-user or an administrator) to define the attributes which may apply to particular nodes in the directory. This step may be used to customize the filtering technology to the particular purpose for which it is being utilized. Preferably, when one organizes data, there may be some theme to how that data is organized wherein a particular node may comprise children which share one or more common elements. The filter may be designed to recognize that a particular node comprises children with such common elements. It may then allow a user, via the graphical user interface, to either filter on such elements in a free-style manner or it may present a template comprising such elements in “fill-in-the-blank”, drop-down menu, or other criteria selection means. The criteria may be as broad or specific as desired by the particular application and needs of the industry. The user may further have the control to use whichever attributes he wishes to perform the filter operation. The user may filter on only one attribute or on as many as provided by the template or they may also define such criteria in a freeform manner similar to, for instance, running a SQL (structured query language) statement. Once the computer has received the filter attributes, it may perform the filter operation on the children of the selected node and present the results to the user. Examples of more specific organizational structures may include a customer hierarchy, an account hierarchy or a product hierarchy. A customer hierarchy logically pertains to an organization of a set of customers (applicable to virtually any industry). An account hierarchy logically pertains to an organization of a set of accounts (again, applicable to virtually any industry). A product hierarchy logically pertains to an organization of a set of products (again, applicable to virtually any industry). Attributes specific to each of these purposes may be programmed into the computerized graphical user interface which presents the filtering options to the user.

In another embodiment, a user may choose to only search a particular number of levels deep in the hierarchy. The graphical user interface may permit such an option to be designated and then implement it in the filter operation. The processor may be programmed to present a user with an option to select a specified number of layers deep for filtering a node and then filter the node/directory according to said number of layers selected by the user.

In another embodiment, filter operations may be performed on more than one disparate node either simultaneously or successively. For instance, if a directory structure comprises a set of customer accounts divided into different regions (North, South, East, and West) and a user wishes to pull all of the accounts that are in arrears from the North and West regions, they may designate the North and West regions and then run the filter operation on those two nodes.

In another embodiment, nodes may be filtered in succession while maintaining the filtered view from the previous filtering operation. Thus, an example of this functionality may use the previous example of a customer account directory structure comprising four different regions: North, South, East, and West. A user may first wish to filter the Northern region for specific criteria about a customer, e.g., which accounts are thirty days past due. After seeing the filtered results through the graphical user interface, the user may further decide to filter the Eastern accounts for those accounts that are sixty days past due. The return set may feature the Northern accounts that are thirty days past due and the Eastern accounts that are sixty days past due. The view of the Southern and Western accounts may remain unfiltered. This successive filtering may performed on the same nodes, different nodes, and/or sub-nodes until a desired result set is achieved. It is also possible to select multiple nodes for filtering at the same time.

In another embodiment, the invention may be implemented as a program stored on some computer-readable medium (CD, disk, downloadable file) which may be installed to provide the functionality described throughout this application including, but not limited to, reading a file comprising a logical hierarchical tree representation of a set of data; presenting a graphical user interface comprising a visual representation of said tree wherein said interface allows a user to select a particular node in said tree and define a set of criteria by which to filter the children of said node; filtering the node (children of the node) on the basis of a set of inputs received from said user; and presenting a set of results via said graphical user interface wherein said results are presented in the same organizational schema associated with said directory.

In another embodiment, it should be understood that the user may effectuate the functionality described in this application through a graphical user interface which is designed to facilitate the filtering operations and either allow a user to enter filtering criteria on a freeform basis and/or lead a user through the selection of criteria through a variety of templates. In such a system, there may be a graphical user interface including a display and a selection device which facilitates filtering a directory displaying a retrieved set of directory entries from a directory file; displaying the set of directory entries on the display in a hierarchical tree format; receiving a selection signal indicative of the selected subset of said directory entries and a selected set of filter criteria; and, in response to the signal, performing a filter operation on the children of said directory entries and displaying a set of desired directory entries in said hierarchical tree format.

### BRIEF DESCRIPTION OF THE DRAWINGS

Preferred embodiments are provided in the accompanying detailed description which may be best understood in conjunction with the accompanying diagrams where like parts in each of the several diagrams are labeled with like numbers, and where:

FIG. 1 represents a logical diagram of a hierarchical tree

FIG. 2A depicts a “flow chart” tree.

FIG. 2B depicts a Vertical tree.

FIG. 2C illustrates a Hyperbolic Tree.

FIGS. 3A-B present some embodiments of a filtered vertical tree.

FIG. 4A represents an embodiment of the filtering technology in which the filter is integrated with a set of Customer Care Agent and business billing functions as a single technology (i.e. Java), with a single user interface.

FIG. 4B represents an embodiment of the filtering technology in which the filter is integrated with a set of Customer Care Agent/Business Billing functions in both web technology and using Java. The user interface in this embodiment integrates both technologies.

FIG. 4C represents an embodiment of the filtering technology in which the filter is integrated with a set of Customer Care Agent functions implemented in web technology. Business billing functions and a subset of Customer Care Agent functions may be implemented in Java to support all business billing tasks.

FIG. 4D represents an embodiment of the filtering technology in which the filter is integrated with a set of Customer Care Agent functions implemented in web technology. Business billing functions may be implemented in Java. In this embodiment, there is no overlap or duplication of functions.

FIG. 4E represents an embodiment of the filtering technology in which the filter is implemented as an applet in a web application.

FIG. 5 presents a view of an account hierarchy.

FIG. 6 illustrates a hierarchy filtered according to any filters that have been previously applied to it.

FIGS. 7A-D illustrate a step-by-step method of filtering a vertical tree in one embodiment of the invention.

FIG. 8 illustrates a simple tree structure.

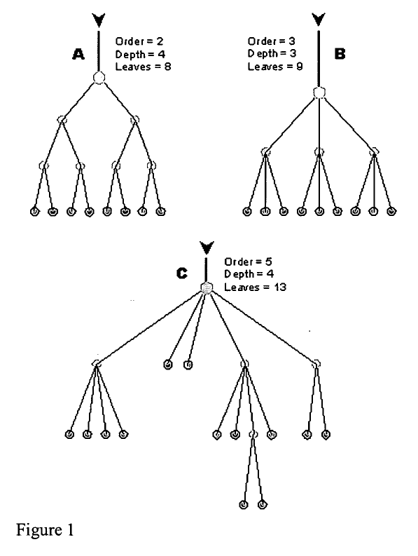

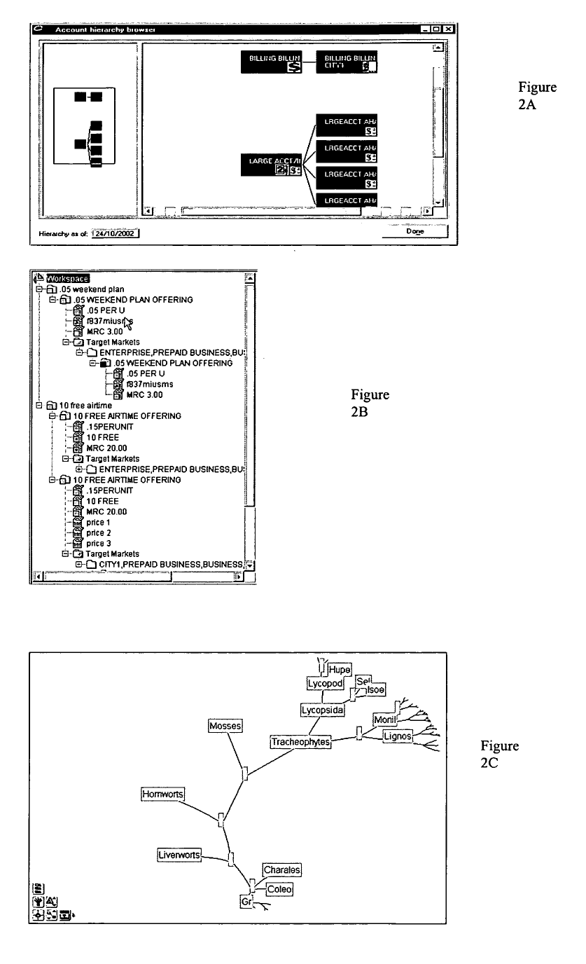

### DETAILED DESCRIPTION OF THE EMBODIMENTS

Various embodiments of the invention comprise a user interface that assists in managing directories. The described functionality may be utilized in practically any industry, however, for exemplary purposes only, embodiments disclosed herein may include account hierarchies in a business billing environment.

Directories may comprise files. Directories may also comprise computerized representations of any information which may be hierarchically displayed including: file names, customers, accounts, products, services, historical data and more.

In a preferred embodiment, there may be a browser-based implementation incorporating Java applets for the complex account hierarchy functionality. Other technologies may be used for the implementation and still keep the key features of the design in place.

In one embodiment, elements of the design of the user interface may include a vertical tree, which displays a representation of an account hierarchy. An account hierarchy may show the nodes, representing the accounts, their children and their relationships.

It would also be possible to support other styles of information reproduction including flowcharts and radial trees.

In an embodiment where the directory comprises a subscription list, the GUI may show the list of subscriptions for the selected node in the hierarchy. Subscriptions may be listed outside the account hierarchy and/or within the vertical tree.

Hierarchies may be represented visually by a tree structure. Icons may be used to depict nodes in the hierarchies. Each node may represent an individual item, such as an account and/or a subscription.

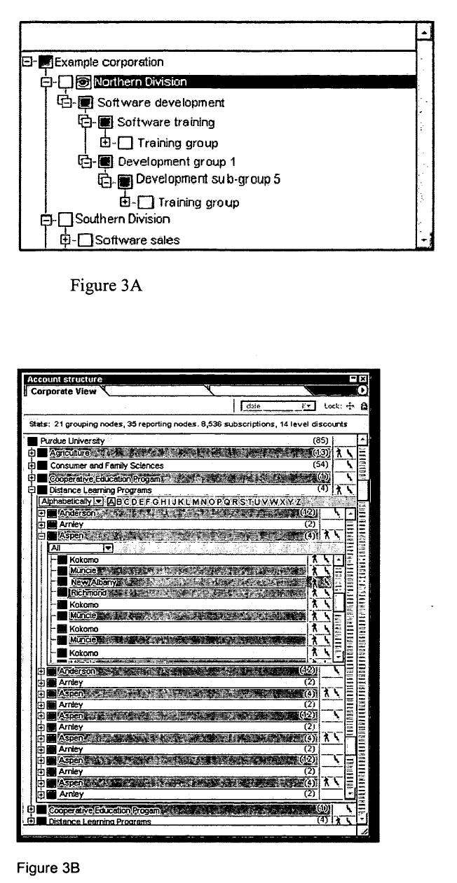

A user may filter the tree view so that only a subset of nodes are displayed. Referring to FIG. 3A, filtering differs from searching a hierarchy. A search merely produces a listing of those items which fulfill the designated criteria. A filtering operation produces a representation of the relevant hierarchy with the unwanted or irrelevant nodes, sub-nodes, and/or leaves removed from the representation of the structure. In an alternative embodiment, the nodes, which are filtered out, may also be represented in a manner which distinguishes them from the desired nodes (i.e., a different color, font, etc.).

Alternative views of the hierarchy could be used to provide different information to the user. For example, one view could show the discount structure applied to the accounts and another could show the multi-national organization of the accounts.

In a preferred embodiment, the functionality may enable businesses to manage their own accounts on-line. Some enterprises may wish to support hierarchies that contain millions of nodes. Such account hierarchies may be complex including multi-national nodes with different currencies, languages and tax systems.

As an example, a large account could have the following statistics:

| | |
|---|---|
| Number of liable accounts | 60,373 |
| Number of reporting accounts | 13 |
| Number of grouping accounts | 75 |
| Number of subscriptions | 112,604 |
| Total number of nodes (accounts | 173,065 |
| and subscriptions) | |

Mass actions may be effected within the hierarchy (from right-click menus, the toolbar and the actions list). The result set returned by the filtering operation may be used to effect any number of further options including, for example, bulk functions, such as editing a large number of subscriptions. The filtered view may also support tasks such as updating the details of a subset of the accounts (the result set) within the hierarchy; expiring a subset of the subscription under a node; and adding nodes or subscriptions en masse.

Business billing tasks supported via the filtering technology may include setting up/managing hierarchies as well as generating/viewing statements and reports for a filtered subset of an account hierarchy. More specialized tasks may include adding/updating/changing/deleting services for a filtered subset.

User Interface

The user interface may support filtering within the hierarchy. A quick filter tool may enable the user to carry out a quick filtering operation. The user may also launch a “full filter” screen which comprises the full set of filter fields.

A hierarchy view may include one or more of the following types of information for each node:

(1) An icon which illustrates the type of node (product node, account node, customer node, regional node, etc).

(2) An identifier of the node which, typically, comprises a name. For instance, the name of the account holder may be the identifier for an account node, which comprises children representing the services assigned to that account.

(3) The number of immediate sub-nodes may provide the user with some information regarding the possible consequences of expanding the node.

A toolbar may be provided to allow the user to build a hierarchy quickly and easily using a method similar to that employed in many graphical applications. The toolbar may contain buttons for each of the possible node types within the hierarchy. These node types may be customized by the user. To build a hierarchy, the user may click on a node type in the toolbar and then either “drag and drop” that node into the required position in the hierarchy or click it into the required position in the hierarchy. The user may also be prompted to enter a set of node details.

Templates may be provided as a quick way for the user to create standardized types of accounts and subscriptions within the hierarchy. For example, an enterprise might define ten basic types of user that can be added to accounts in the hierarchy. When adding a new subscription, the user may select one of these ten “templates” and a predetermined number of the details would then be pre-filled. These fields may be customized and/or remaining fields may be filled in by the user. These fields may also be used to filter the hierarchy once it has been built.

Referring to FIG. 3B, when a large hierarchy is viewed, the user may also need tools that allow the hierarchy to be filtered. For example, if the user wants to expand a node that has 6,000 immediate sub-nodes, then he/she would be faced with a long list to scroll through in order to find the sub-node(s) of interest. Therefore, an embodiment provides an option to filter the sub-nodes, rather than viewing them all.

When a user selects a task that requires him/her to deal with an account in a hierarchy (for example, to add a new subscription), then he/she does not necessarily require access to the full hierarchy. Therefore, an embodiment may provide a user with confirmation that the correct node in the hierarchy has been selected by providing some indication of the parentage of the node. An embodiment may include a “hierarchy position indicator”, if the selected account is part of a hierarchy. This shows the immediate path from the root node in the hierarchy to the current node. This allows the user to confirm that the correct node has been selected. If it is incorrect, the user has the option to switch positions.

The user can apply multiple, complex filters, to one or more nodes within the hierarchy. Complex filters may comprise more than one filter criterion. Of course, simple filters are also permissible. This may reduce the number of nodes displayed and may allow the user to focus on the part(s) of the tree relevant to the current task. Because the filtered view is just one of the possible views of the tree, the user can switch back to the full view of the tree without having to remove all the filters. A user may re-view filtered views between the original view and the current view (intermediate filtered views).

An Embodiment of Manipulating an Account Hierarchy

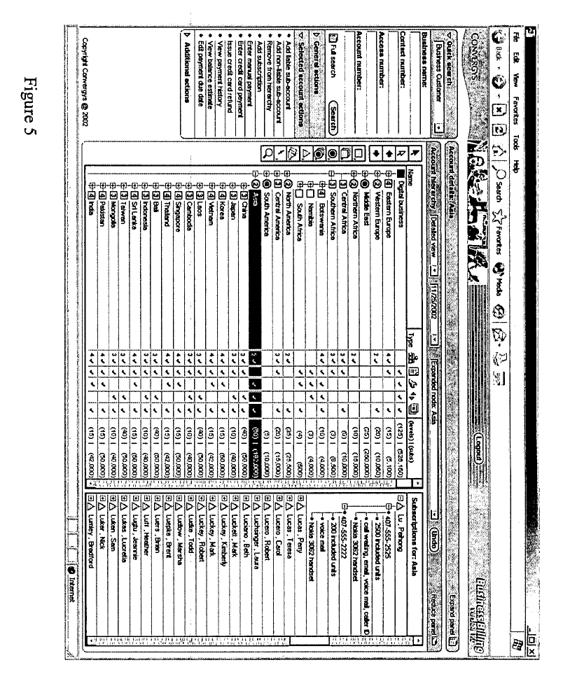

Referring to FIG. 5, a user may retrieve an account through the application which presents a GUI (graphical user interface) to the user. Multiple views of the hierarchy may be presented including a Basic View and Detailed View. “Detailed view” may include additional details not available in the “Basic view” such as the attributes of each node. Example attributes might include whether or not the account is liable, the reporting type of the account and whether or not the account has been designated as a large account. Some of the key attributes of each node may also be indicated in the nodes' icons.

This view may also show the tree structure of the subscriptions associated with each account. Each subscription can be expanded to view the access number(s) for that subscription. Each access number can be expanded to view the services on that number. (This structure may vary according to the type of subscription.). The user can expand and reduce the Account Hierarchy panel.

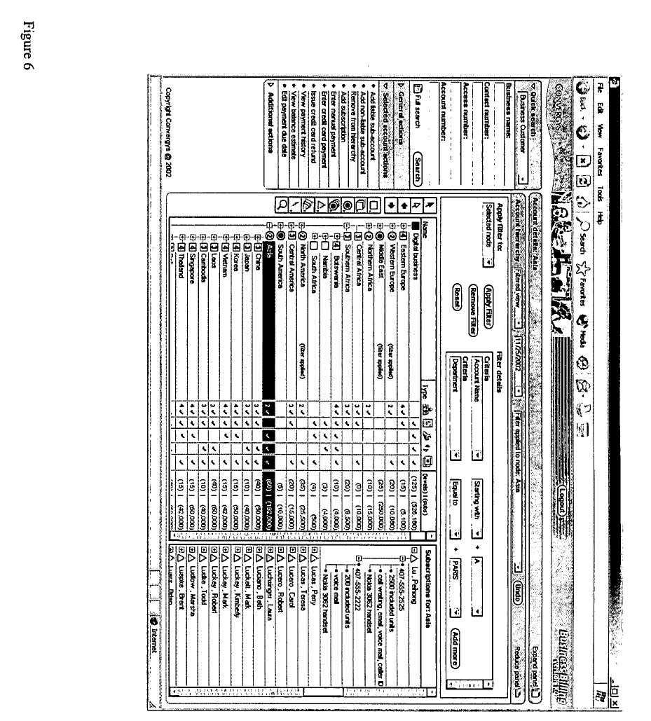

Referring to FIG. 6, the user may select “Filtered View” from a choice box in the Account Hierarchy panel title bar to access the filtering options. This view may also show the hierarchy filtered according to any filters that have been previously applied to it.

The user can apply a filter by entering the details of the filter in the fields at the top of the window. The user can apply the filter to the currently selected account node, a selected set of one or more nodes (including the entire tree if the root node is selected), to a list of subscriptions, and/or combinations thereof.

If the user selects to filter a node, an indicator may be placed next to the node's name in the hierarchy. The node may be expanded and those sub-nodes matching the filter criteria may be displayed.

The user may remove a filter by selecting the node or tree and clicking “Remove filter” in the panel at the top. The user can easily switch to a completely unfiltered view of the tree by selecting “Detailed view” or “Basic view” from the options in the title bar of the Account Hierarchy panel.

This tool enables users to apply filters to the children of a selected subset of a hierarchy. By applying filter criteria, users are able to reduce the displayed hierarchy and view only the data necessary to complete a task, while maintaining the hierarchical structure of the data. Multiple filters may be applied to nodes within a hierarchy in successive order. That is, a user can select a node, filter it, then select another node in the tree, and filter it as well. In another embodiment, multiple filters may be applied to the same node successively. In a preferred embodiment, a list of filters, which have been applied to a node, may be displayed.

Another Embodiment of Manipulating an Account Hierarchy

The user may select a node and access an option to filter it. The user may then be presented with one or more possible attributes to use as filter criteria: these may be generic attributes or the attributes of the child nodes associated with the selected node. For example, if the user selects an account node to filter and that account node has products below it, the user may see product attributes as the filter criteria. These attributes may be the same attributes which are presented to the user when they are initially setting up the hierarchy.

The user may also select how many levels of the tree below the selected node to which the filter should be applied. On applying the filter, the hierarchical display may refresh to show only those child nodes below the selected node that matched the filter criteria. If multiple levels were filtered, the hierarchical nature of those levels may be preserved.

And Yet More Embodiments of Manipulating an Account Hierarchy

A user may access the customer hierarchy for a business customer. As an example, the hierarchy may comprise thousands of customer nodes and may be ten levels deep. The user may wish to carry out an action on all customer nodes in a particular region (e.g. to update them to have a new service just available in that region). The user may choose to filter the hierarchy using the region as the filter criterion. After applying the criterion, those customer nodes in the selected region may be displayed. In order to display the matching nodes within the hierarchical structure, some non-matching nodes may need to be included, but these may be “grayed out” or otherwise designated as irrelevant.

As another example, a user may select a customer node within a hierarchy. Purely as an example, that customer may have thousands of products associated with it. The user may wish to change the price plan on a subset of the products. The user may select to filter just this node and apply multiple criteria to filter the immediate child products. After applying the criteria, the matching products may be displayed. Then the user may effect a bulk operation to change the price plan on the returned subset of products.

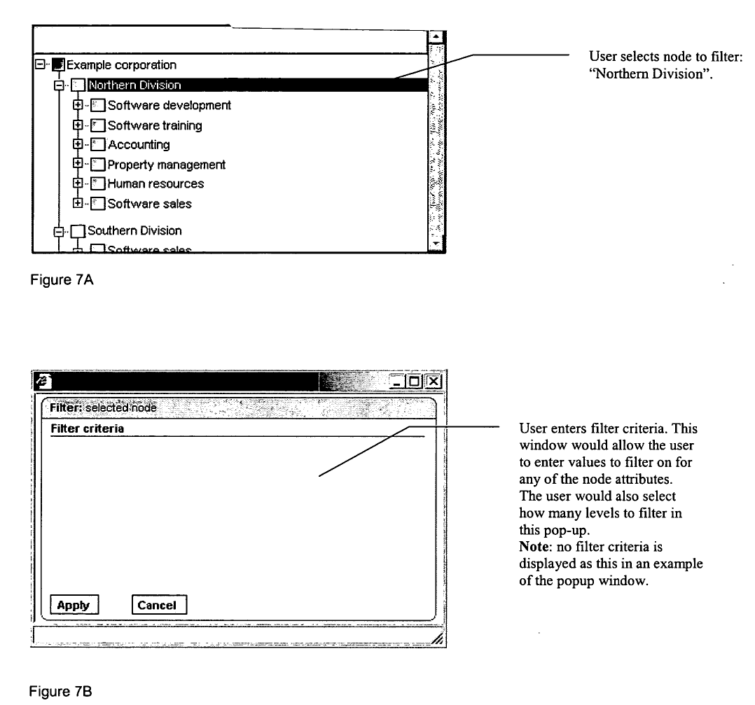

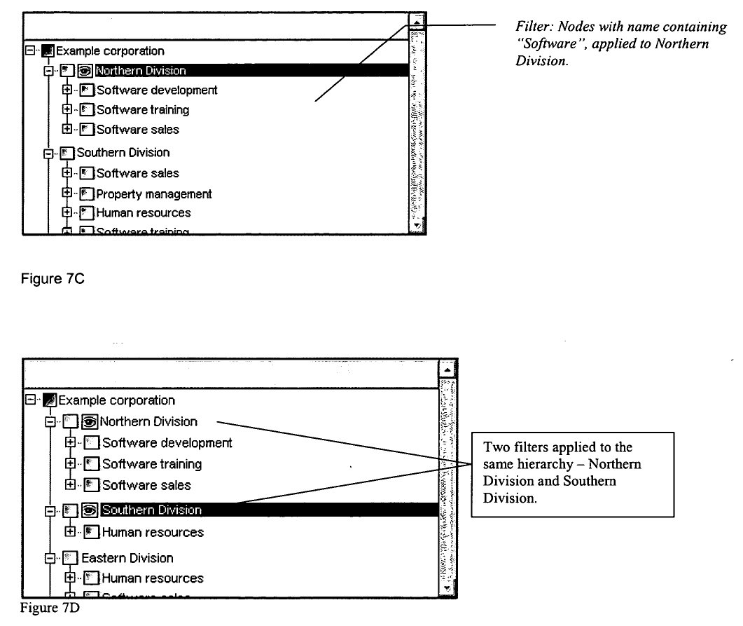

As another example, referring to FIG. 7A, a user may open a hierarchy and view it through a browser or other computer application. The user may filter “Northern Division” to view only those nodes under it relating to “Software”. Referring to FIG. 7B, the user may enter their desired filter criteria. The user, in an alternative embodiment, may also fill out the filter criteria through a predetermined template comprising specific attributes related to the particular hierarchy, the nodes being filtered, and/or the children of the selected node(s). Referring to FIG. 7C, once the filter is applied, the user may be presented with a refreshed view of the hierarchy which shows “Northern Division” after the filter has been applied. As shown, the node “Southern Division” has now moved up in the GUI as there are fewer nodes in the display. Referring to FIG. 7D, the user may apply a filter to “Southern Division” to only display the nodes directly under it that are related to “Human resources. The user may select “Southern Division” and enter the desired criteria. A filtered view may show “Southern Division” after the second filter has been applied. Thus, two different filters (the filters may also be the same if desired) have been applied within the same hierarchy but to different branches within that hierarchy. Additional filters may be applied to the filtered set of results at any node within the hierarchy. The icon on “Northern Division” indicates that a filter has been applied to this node.

The GUI may not hide all other nodes in the hierarchy that do not match the filter criteria, just those directly under the selected node.

Conceptual Model

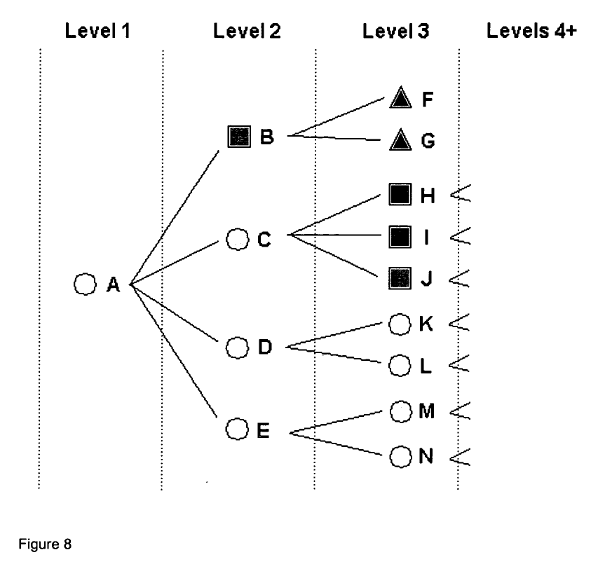

Referring to FIG. 8, the user may select a node (any node) in the hierarchy and choose to filter the nodes below it. The criteria available for filtering may be specific to the node selected and its child nodes. After applying a filter, the display may be refreshed to show only the nodes matching the filter criteria and any other nodes that must be displayed to maintain the structure. The circles, squares and triangles may represent different types of nodes (i.e., customer nodes, account nodes, and product nodes).

A user may select (for example), Node C and apply a filter to the nodes below it (H, I and J, and potentially their child nodes as well, depending on what the user specifies) to display only those that match certain criteria. The filter criteria may be any attributes associated with the square node type. Filters can be applied to multiple different nodes within the tree simultaneously or successively. For example, one filter could be applied to node C and another to node D. Indeed the filter criteria for each node may be different depending on the type of data stored in each node.

Product Line Architecture Recommendation

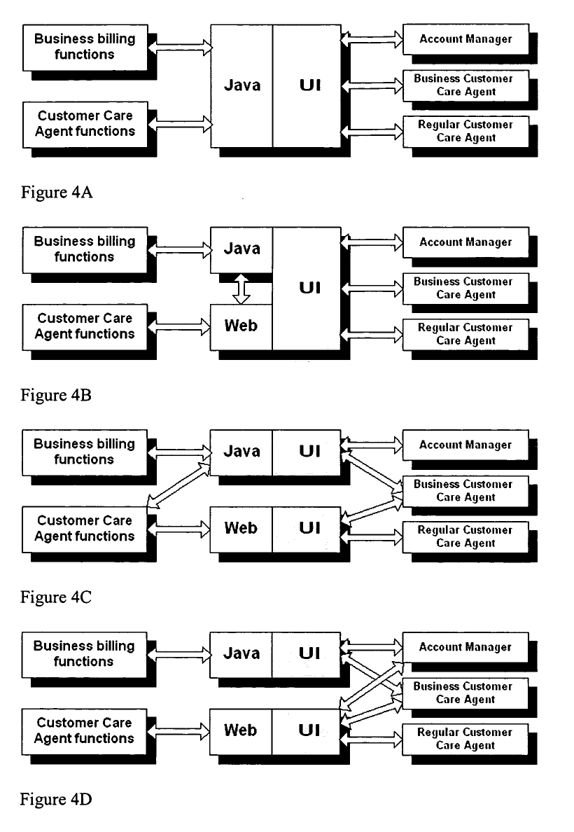

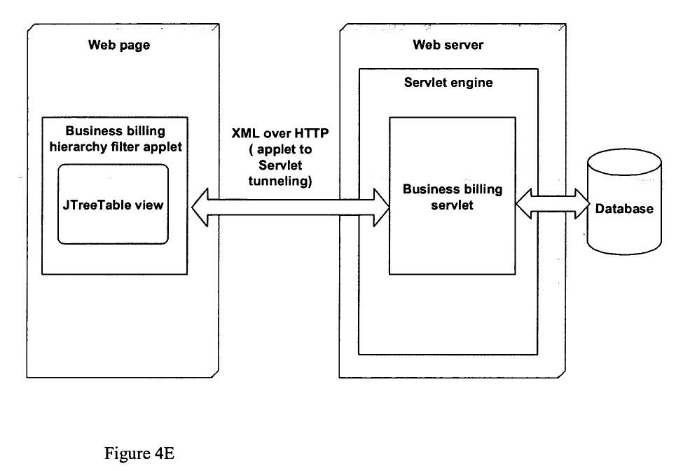

In a preferred embodiment, the business billing user interface may operate as a web application. It may use Java applets to implement any complex functionality. See, FIGS. 4A-D for various interface embodiments of the behind the scenes implementation.

Referring to FIG. 4E, the filter may be implemented as:

(a) an applet with in a web application. An applet may be a little application. On the Web, using Java, an object-oriented programming language, an applet is a small program that can be sent along with a Web page to a user. Java applets can perform interactive animations, immediate calculations, or other simple tasks without having to send a user request back to the server.

(b) a standalone Java application. Java is a programming language expressly designed for use in the distributed environment of the Internet. It was designed to have the “look and feel” of the C++ language, but it is simpler to use than C++ and enforces an object-oriented programming model. Java can be used to create complete applications that may run on a single computer or be distributed among servers and clients in a network. It can also be used to build a small application module or applet for use as part of a Web page. Applets make it possible for a Web page user to interact with the page. One of the many characteristics of Java is that the programs you create are portable in a network. Source programs may be compiled into what Java calls byte code, which can be run anywhere in a network on a server or client that has a Java virtual machine. The Java virtual machine interprets the byte code into code that will run on the real computer hardware. This means that individual computer platform differences such as instruction lengths can be recognized and accommodated locally just as the program is being executed. Platform-specific versions of a program are no longer needed.

(c) Other technology may include, but not be limited to, ActiveX components. ActiveX is the name Microsoft has given to a set of “strategic” object-oriented programming technologies and tools. The main technology is the Component Object Model (COM). Used in a network with a directory and additional support, COM becomes the Distributed Component Object Model (DCOM). When writing a program to run in the ActiveX environment, one creates a component or a self-sufficient program that can be run anywhere in the ActiveX network. This component is known as an ActiveX control. ActiveX is Microsoft's answer to the Java technology from Sun Microsystems. An ActiveX control is roughly equivalent to a Java applet. One of the main advantages of a component is that it can be re-used by many applications (referred to as component containers). A COM component object (ActiveX control) can be created using one of several languages or development tools, including C++ and Visual Basic, or PowerBuilder, or with scripting tools such as VBScript.

The applet can be implemented using a Model-View-Controller design. In object-oriented programming development, model-view-controller (MVC) is the name of a methodology or design pattern for successfully and efficiently relating the user interface to underlying data models. It may be used in programming languages such as Java, Smalltalk, C, and C++. The model-view-controller pattern proposes three main components or objects to be used in software development:

A Model, which represents the underlying, logical structure of data in a software application and the high-level class associated with it. This object model may not contain any information about the user interface.

A View, which is a collection of classes representing the elements in the user interface (all of the things the user can see and respond to on the screen, such as buttons, display boxes, and so forth).

A Controller, which represents the classes connecting the model and the view, and is used to communicate between classes in the model and view.

The model comprises a tree data structure obtained from a backend servlet. A servlet is a small program that runs on a server. With a Java running on the server, such programs can be implemented with the Java programming language. Rather than causing a separate program process to be created, each user request may be invoked as a thread in a single daemon process, meaning that the amount of system overhead for each request is slight.

The View may be implemented using a custom Java component that is a combination of the standard Jtable and Jtree widgets. This custom component is called JtreeTable. The Applet may communicate with the servlet that provides the data to be displayed using “applet to servlet” communication or tunneling. The message format may be used to exchange data between the applet and the servlet can be an XML document. JTable is a standard Java Swing component that may provide a table display (like a spreadsheet). JTree is a standard Java Swing component that may provide a Tree display. JTreeTable may comprise a customized component that combines the display attributes of both JTree and JTable to display the hierarchy. The JTreeTable may be built using Java Swing component model with an MVC design. A class called JTreeTableModel may represent the model and JTreeTable may represent the view and the control.

The applet may start initially and display the default hierarchy view. The user may use the filter window to build the filter criteria. After the filter is built the applet may submit the filtering command to the servlet using, for instance, applet to servlet tunneling. The servlet may process the filtering criteria against the database using SQL (or similar means) and send the filtered tree back to the applet for the applet to display.

The Applet may also be implemented using JDK1.4 using the Java Swing capabilities.

We claim:

1. A computerized method for filtering a directory comprising:
a. presenting a directory to a user wherein said directory comprises an organizational schema;
b. receiving a signal from said user indicative of a particular node in said directory which said user wishes to filter a set of children associated with said particular node;
c. allowing said user to choose a filter criterion;
d. receiving a signal from said user indicative of said filter criterion;
e. filtering said particular node; and
f. presenting a set of results that are presented in the same organizational schema associated with said directory.

2. A computerized method for filtering a directory as claimed in claim 1 further comprising:
a. after said “receiving a signal indicative of said particular node” step, selecting a set of attributes associated with said particular node;
b. presenting said set of attributes to said user;
c. allowing said user to select a subset of said set of attributes to filter said particular node;
d. receiving a signal from said user indicative of said subset;
e. filtering said particular node according to said subset; and
f. presenting said results.

3. A computerized method for filtering a directory as claimed in claim 2 wherein
a. said particular node is a customer node; and
b. said set of attributes is a set of customer attributes.

4. A computerized method for filtering a directory as claimed in claim 2 wherein
a. said particular node is a product node; and
b. said set of attributes is a set of product attributes.

5. A computerized method for filtering a directory as claimed in claim 1 wherein said directory is displayed in a hierarchical tree format.

6. A computerized method for filtering a directory as claimed in claim 1 wherein said filtering method further comprises the steps of:
a. presenting a user with an option to select a specified number of layers deep for filtering said particular node;
b. allowing said user to specify said number of layers; and
c. filtering said particular node according to said specified number of layers.

7. A computerized method for filtering a directory as claimed in claim 1 wherein
a. after said “presenting a directory to a user” step, allowing said user to select at least two nodes in said directory;
b. receiving a signal from said user indicative of said nodes in said directory which said user wishes to filter;
c. filtering said nodes; and
d. presenting a set of results in the same organizational schema associated with said nodes in said directory.

8. A computerized method for filtering a directory as claimed in claim 7 wherein
a. after said “receiving a signal from said user indicative of said nodes in said directory which said user wishes to filter” step, allowing said user to select at least two criteria for filtering said node;
b. receiving at least one signal from said user indicative of said at least two criteria; and
c. filtering said nodes with said at least two criteria.

9. A computerized method for filtering a directory as claimed in claim 1 wherein
a. after said “presenting a directory to a user” step, allowing said user to select a first node in said directory;
b. receiving a signal from said user indicative of said first node in said directory which said user wishes to filter;
c. filtering said first node;
d. presenting a set of results in the same organizational schema associated with said first node in said directory;
e. allowing said user to select an additional node in said directory;
f. receiving a signal from said user indicative of said additional node in said directory which said user wishes to filter;
g. filtering said additional node;
h. presenting a set of results in the same organizational schema associated with said first node and said additional node in said directory; and
i. repeating steps e-h until a set of desired results is attained.

10. A computerized method for filtering a directory as claimed in claim 1 wherein
a. after said “receiving a signal from said user indicative of a node in said directory which said user wishes to filter” step, allowing said user to select at least two criteria for filtering said node;
b. receiving a signal from said user indicative of said at least two criteria; and
c. filtering said nodes with said at least two criteria.

11. A computerized system for filtering a directory comprising
a. a directory file which specifies a set of logical locations for a set of computerized files;
b. a storage component for storing said directory file;
c. a visual component for graphically displaying an organizational schema associated with said directory file;
d. a processing means configured to
access said directory file from said storage component and display said directory file to a user via said visual component;
receive a signal from said user indicative of a node in said directory which said user wishes to filter;
allow said user to choose a filter criterion;
receive a signal from said user indicative of said filter criterion;
filter a set of children associated with said node in said directory;
present a set of results via said visual component in the same organizational schema associated with said directory.

12. A computerized system for filtering a directory comprising
a. a directory file which specifies a set of logical locations for a set of computerized files;
b. a storage component for storing said directory file;
c. a visual component for graphically displaying an organizational schema associated with said directory file;
d. a processing means configured to
access said directory file from said storage component and display said directory file to a user via said visual component;
receive a signal from said user indicative of a node in said directory which said user wishes to filter;
select a set of attributes associated with said node;
present said set of attributes to said user via said visual component;
allow said user to select a subset of said set of attributes to filter said directory
receive a signal from said user indicative of said filter criterion;
filter a set of children associated with said node according to said subset; and
present a set of results via said visual component in the same organizational schema associated with said directory.

13. A computerized system for filtering a directory as claimed in claim 12 wherein said processing means is further configured to
a. present a user with an option to select a specified number of layers deep for filtering a node;
b. allow a user to specify said number of layers; and
c. filter said directory according to said specified number of layers and said subset.

14. A computerized system for filtering a directory as claimed in claim 13 wherein said processing means is further configured to
a. allow a user to select at least two nodes in said directory;
b. receive a signal from said user indicating said nodes in said directory which said user wishes to filter;
c. filter a set of children associated with said nodes; and
d. present a set of results in the same organizational schema associated with said nodes in said directory.

15. A computerized system for filtering a directory as claimed in claim 14 wherein said processing means is further configured to
a. allow said user to configure at least two criteria for filtering said nodes;
b. receive a signal from said user indicating said at least two criteria; and
c. filter a set of children associated with said nodes with said at least two criteria.

16. A computer-readable medium having computer-executable instructions for performing a method comprising:
a. reading a file comprising a logical hierarchical tree representation of a set of data;
b. presenting a graphical user interface comprising a visual representation of said tree wherein said interface allows a user to select a node in said tree and define a set of criteria by which to filter a set of children associated with said node;
c. filtering said set of children on the basis of a set of inputs received from said user;
d. presenting a set of results via said graphical user interface wherein said results are presented in the same organizational schema associated with said directory.

17. In a computer system having a graphical user interface including a display and a selection device, a method of filtering a directory, the method comprising:
a. retrieving a set of directory entries from a directory file;
b. displaying the set of directory entries on the display in a hierarchical tree format;
c. receiving a selection signal indicative of the selected subset of said directory entries and a selected set of filter criteria;
d. in response to the signal, performing a filter operation on a set of children associated with said directory entries and displaying a set of desired directory entries in said hierarchical tree format.
